(19) United States
(12) Patent Application Publication
(10) Pub. No.: US 2008/0023484 A1
(43) Pub. Date: Jan. 31, 2008

(54) Device by Gas Cylinder

(75) Inventor: Per Lothe, Forresfjorden (NO)

Correspondence Address: Andrus, Sceales, Starke & Sawall, LLP, Suite 1100, 100 East Wisconsin Avenue, Milwaukee, WI, 53202, US

(73) Assignee: Knutsen OAS Shipping AS, Haugesund (NO)

(21) Appl. No.: 11/867,455

(22) Filed: Oct. 4, 2007

Related U.S. Application Data
(62) Division of application No. 10/450,796, filed on Oct. 7, 2003.

(30) Foreign Application Priority Data
Dec. 15, 2000 (NO) 20006398

(51) Int. Cl. F17C 1/02

(52) U.S. Cl. 220/586

(57) ABSTRACT

A compression tank device (1) for sea transport of petroleum products, comprising a relatively elongated metallic cylindrical portion (4) and end gables (6, 6′), the cylindrical portion (4) being fixedly connected to the end gables (6, 6′) through sealing connections (16, 16′), and the cylindrical portion (4) of the compression tank (1) and a portion of the end gables (6, 6′) being braided with a fibrous material (8), the fibrous material (8) being oriented mainly in the circumferential direction of the compression tank (1).

This invention relates to a gas cylinder for sea transport of natural gas at ambient temperature and relatively high pressure.

For gas transport across sea stretches several solutions are knows. The gas may be pumped at moderate pressure through a pipe laid on the sea bed to the receiving site. Such solutions require relatively simple and inexpensive equipment at the place of shipment and the place of reception, but the capital costs of such pipe-laying may be very high. At depths greater than 300 m it has earlier been very difficult for pipes to be laid with a satisfactory result. Another drawback of pipe lines on the sea bed is that they are difficult to move once laid.

Other known solutions for gas transport across sea stretches are based on the use of ships or barges. Best known is the so-called Liquefied Natural Gas—LNG—method. The method comprises cooling of gas into liquid form, after which the gas may be transposed in ship tanks at atmospheric pressure.

The method requires considerable investments at both the place of shipment and the place of reception. Since the gas must be cooled to a relatively low temperature, up to one fifth of the gas is spent to drive the cooling and heating processes. Such an energy expenditure just for the processes related to transport is expensive and moreover environmentally doubtful.

Several other ship-based solutions have been proposed, in which the gas is pressurized and/or cooled to achieve a gas density practical for the purpose. Such solutions have had little use in practice, but a solution in which a great number of vertical tubular compression tanks are disposed in modules placed in the hold of a ships has attracted considerable attention. The method is called Pressurized Natural Gas—PNG. According to such a method the gas is compressed to a positive pressure of a couple of hundred bar at the place of shipment, and is then filled into the compression tanks located on the ship. The cooling is limited to a simple and inexpensive removal of the compression heat from the gas, so that the transport temperature will be close to ambient temperature. The major drawback of the PNG method is that, if manufactured in accordance with known techniques, the gas cylinders will occupy too large a portion of the loading capacity of the vessel.

The invention has for its purpose to remedy the drawbacks of the PNG method for the transport of natural gas.

The object is achieved in accordance with the invention through the features specified in the description below and the subsequent Claims.

In a closed cylinder which is subjected to an internal pressure, tensile forces occur axially of the container and along the circumference of the cylinder wall.

According to normal calculating methods, to a cylindrical compression tank it applies that the stress component of the material circumferentially of the cylinder is twice as large as that in the axial direction of the cylinder. It is evident that the wall thickness of the cylinder may be reduced to a considerable degree, if the force effective along the circumference of the cylinder can be absorbed by a structural element other than the cylinder wall. The cylinder wall being surrounded by a tensile material, the cylinder wall will only absorb the axial forces of the container and the relatively small compressive forces created between the fluid pressure within and the surrounding tensile material. If the properties of the surrounding tensile material also include low specific weight, it is possible to reduce the overall weight of the compression container, so that the vessel achieves an acceptable loading capacity.

A compression container according to the invention comprises a metal cylinder, in the following called a cylinder pipe, arranged to absorb the axial forces of the container, and two end gables arranged to absorb all the gable forces occurring. The concave geometry of the end gables does not differ substantially from techniques known in themselves. The cylinder pipe, together with the end gables, constitutes the pressure-tight element. The forces acting along the circumference of the cylinder pipe are absorbed by a fibrous material built round the cylinder pipe. The fibrous material may be braided around dry, but in a preferred embodiment it will be laid in a matrix of thermoset plastic or thermoplastic, so-called composite material.

The transition between the cylinder pipe, end gable and the and portion of the composite material constitutes an area of a complicated stress pattern. A considerable part of the research forming the background of the invention concerns the stress conditions in this area and also the geometric configuration of these transitions.

As most of the common reinforcing fibrous materials, such as fibre glass, coal fibre and aramid fibre exhibit a lower modulus of elasticity than e.g. steel, a fibrous material has a greater elongation than steel when stretched. For example, when pressurized internally, the cylinder pipe of the compression container which is braided with a fibrous reinforcement, could be subjected to forces that will result in the yield point of the cylinder pipe material being exceeded before the fibrous reinforcement is deformed (stretched) sufficiently for it to assume the occurring annular load.

Therefore, it is necessary to modify the stress situation as regards the annular stresses in the cylindrical portion of the compression tank. After the steel compression tank has been manufactured and the fibrous reinforcement applied, the tank is subjected to an internal pressure of a magnitude sufficient for the yield point of the cylinder pipe of the compression tank to be exceeded. The circumference of the pipe is thereby permanently extended, a pre-stressing of the braided fibre thereby having taken place. In a non-pressurized state the cylinder pipe is annularly subjected to compression due to a compressive force from the surrounding fibre which is stretched. As the internal pressure of the compression tank increases, the compression of the pipe is reduced because the surrounding fibre in stretched further. At normal working pressure the compression of the pipe wall is relieved, i.e. all annular forces are absorbed by the surrounding fibre, whereas the pipe absorbs the axial load of the compression tank.

The geometric configuration of the transition between the pipe, end gable and the end portion of the surrounding fibre will be explained in the specifying part of the description referring to the appended drawings.

In the following is described a non-limiting example of a preferred embodiment which is visualized in the accompanying drawings, in which;

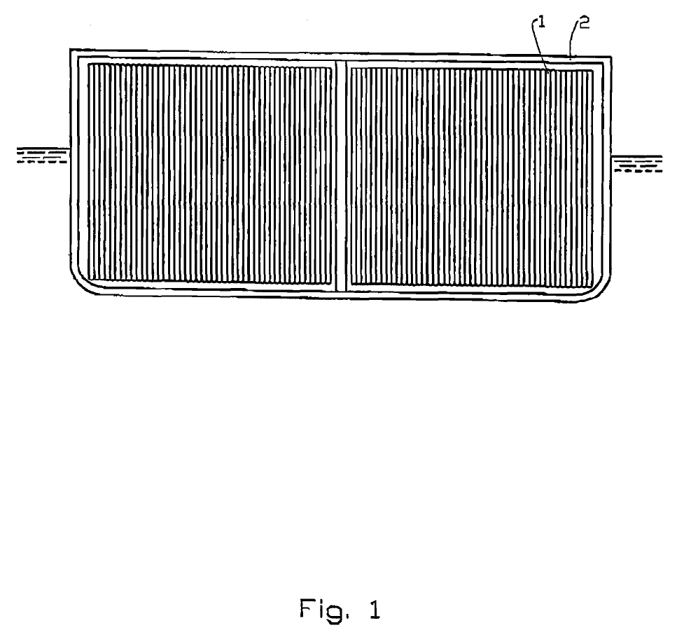

FIG. 1 shows schematically a cross-section of a ship, in which a plurality of compression tanks are arranged vertically; and

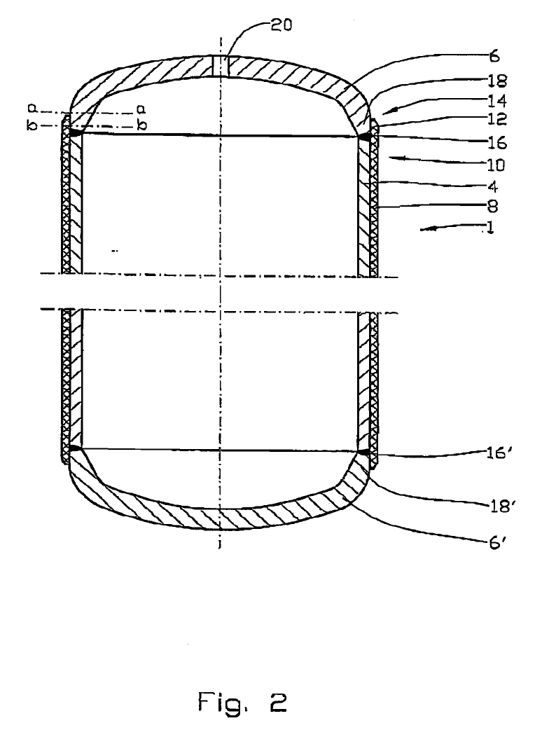

FIG. 2 shows in a section a highly shortened compression tank according to the invention.

In the drawings the reference numeral 1 identifies a compression tank which may be used for gas transport in a ship 2, comprising a metallic cylinder pipe 4, two end gables 6, 6′ and a braided fibrous material B. The cylinder pipe 4 and the fibrous material 8 form a pipe portion 10, whereas the end gable 6 and the end portion 12 of the fibrous material form a gable portion 14.

After the fibrous material 8 has been braided, the cylinder pipe 4 is pressure-treated to achieve a favourable stress pattern, such as explained in the general part of the description.

In FIG. 2 the end gables 6 and 6′ are connected to the cylinder pipe 4 by means of welded joints 16 and 16′, respectively. It is technically/economically favourable for the pipe 4 to have a uniform cross-section in its entire length. The end portion 12 of the fibrous material 8 projects beyond the welded joints 16, 16′. The transition zone, in terms of stress, from the pipe portion 10, in which the annular stresses are absorbed by the fibrous material 8, to the gable portion 14, in which the annular stresses are absorbed by the metal gable 6 is thus laid on the gable sides of the welded joints 16, 16′. Therefore, the cylindrical portions 18, 18′ of the end gables 6, 6′ may typically be somewhat longer than those of end gables 6 of a configuration known in itself. Another particular feature of the invention is that at the cylindrical portions 18, 18′ of the gables 6, 6′, relatively great cross-sectional changes are provided. Such a cross-sectional change reflects the change in stress condition exerted through the force absorption of the braided fibre on the metallic material within. Immediately adjacent to the end portion 12 of the braided fibre 8, in section a-a, see FIG. 2, the metal cross-section of the cylindrical portion 18 of the end gable 6 absorbs the annular and axial forces of the compression tank. In section b-b, see FIG. 2, the metal cross-section absorbs the axial force of the compression tank 1, whereas the braided fibre 8 absorbs the annular force of the compression tank 1.

Filling and emptying of the compression tank 1 take place through a pipe arrangement not shown, which is sealingly connected to an opening 20 in the gable 6.

A compression tank according to the invention is particularly well suited for elongated tanks, as it is not necessary to use fibres running longitudinally. The relatively light construction of the tank allows the use of the energy efficient PNG transport method, which has previously, for practical reasons, not obtained particularly wide use.

1-11. (canceled)

12. A method of making a compression tank device for sea transport of petroleum products, the method comprising the steps of:
providing an elongated metallic cylindrical portion;
sealingly coupling end gables to opposing ends of the cylindrical portion;
surrounding the cylindrical portion and a portion of the end gables with a layer of fibrous material, the fibrous material being oriented mainly in the circumferential direction of the compression tank device; and
subjecting the compression tank device to a predetermined amount of internal pressure to permanently extend the cylindrical portion an amount that pre-stresses the layer of fibrous material when the compression tank device is in a non-pressurized state and such that when the compression tank is operated at normal working pressure the annular compressive forces are substantially entirely absorbed by the surrounding layer of fibrous material and the cylindrical portion absorbs only the axial load on the compression tank device.

13. The method of claim 14, wherein the fibrous material is wound.

14. A method of making a compression tank device for sea transport of petroleum products, the method comprising the steps of:
providing an elongated metallic cylindrical portion;
sealingly coupling end gables to opposing ends of the cylindrical portion;
surrounding the cylindrical portion and a portion of the end gables with a layer of fibrous material, the fibrous material being oriented mainly in the circumferential direction of the compression tank device;
selecting an amount of pressure that when applied to the inside of the compression tank device will permanently deform the cylindrical portion to a point where in a non-pressurized state the cylindrical portion is subjected to an annular compressive force from the surrounding layer of fibrous material and where under normal working pressure the annular compressive forces are substantially entirely absorbed by the surrounding layer of fibrous material and the cylindrical portion absorbs only the axial load on the compression tank device; and
applying the selected amount of pressure to the inside of the compression tank.

15. The method of claim 12, wherein the fibrous material is wound.

16-17. (canceled)
